(19) United States
(12) Patent Application Publication
(10) Pub. No.: US 2008/0110087 A1
(43) Pub. Date: May 15, 2008

(54) Wall flower pot mount and post flower pot

(76) Inventor: Ronald T. Serio, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/809,292

(22) Filed: May 31, 2007

Related U.S. Application Data
(60) Provisional application No. 60/803,636, filed on Jun. 1, 2006.

(51) Int. Cl. A01G 9/02

(52) U.S. Cl. 47/65.5

(57) ABSTRACT

A wall flower pot mount for mounting to a wall comprising a backing member for mounting to a wall with spaced apart support members joined to the backing member. The support members have support edges and are separated from one another. A flower pot having a surrounding side wall and a base with a recess formed in the base is provided. The recess has a width greater than the width of the spaced apart support members, such that the flower pot can be slidingly received on the spaced apart support members and supported. When the flower pot is so supported, the flat portion of the flower pot abuts the wall. A post flower pot have a post receiving recess with ribs for holding the post flower pot to the post.

### CROSS REFERENCE TO RELATED APPLICATION

This application claims priority to U.S. Provisional Patent Application No. 60/803,636 filed Jun. 1, 2006, to Serio and entitled “Wall Flower Pot Mount and Post Flower Pot,” the disclosure of which is hereby incorporated by reference.

### BACKGROUND

Presently, there are wall flower pot mounts in use that are hard to use and difficult to install. These wall flower pot mounts oftentimes have a very unnatural appearance. Another problem is that these mounts can fail, resulting in the flower pot falling to the ground or floor.

What is needed is a better wall flower pot mount that is easy to use, is durable, and has a configuration such that it has a pleasing overall appearance.

### SUMMARY

The present invention includes a wall flower pot mount for mounting to a wall. The mount comprises a backing member for mounting to a wall with spaced apart support members joined to the backing member. The support members have support edges and are separated by a first width. A flower pot having a surrounding side wall having a base and a flat portion is provided, and having a recess formed in the base. The recess has a width greater than the width of the spaced apart support members, such that the flower pot can be slidingly received on the spaced apart support members and supported. When the flower pot is so supported, the flat portion of the flower pot abuts the wall.

In another embodiment, the flower pot is supported on a post and has a recess in the bottom thereof having ribs. In another embodiment the ribs are not present.

### BRIEF DESCRIPTION OF THE DRAWING FIGURES

It is pointed out that in the drawing figures like reference numbers have been used to call out the same elements, structures, features and surfaces throughout.

FIG. 1 is a front elevational view of the wall flower pot mount.

FIG. 2 is a right side elevational view of the wall flower pot mount.

FIG. 3 is a top plan view of the wall flower mount.

FIG. 4 is a front elevational view of the flower pot.

FIG. 5 is a rear elevational view of the flower pot;

FIG. 6 is a bottom plan view of the flower pot; and

FIG. 7 is a diagrammatic view of the flower pot supported on the wall flower pot mount.

FIG. 8 is a right side elevational view of a second embodiment of the flower pot and mount wherein the flower pot has a flat base supported on support members.

FIG. 9 is another embodiment of a post flower pot having a bottom with a recess for mounting on a post.

FIG. 9A is a bottom plan view of the post flower pot having a bottom with a recess.

FIG. 10 is an enlarged view of element A shown in FIG. 9.

FIG. 11 is a sectional view of the post flow pot having a bottom with a recess mounted on a post.

FIG. 11A is a perspective view of another embodiment of the post flow pot without ribs.

FIG. 12 is a front elevational view of the one piece wall flower mount mounted to a wall.

FIG. 13 is a right side elevational view of the one piece wall flower mount mounted to a wall.

FIG. 14 is a top plan view of the one piece wall flower mount mounted to a wall.

FIG. 15 is a rear elevational view of the one piece wall flower mount showing the hollow interior of the one piece wall flower mount.

### DETAILED DESCRIPTION

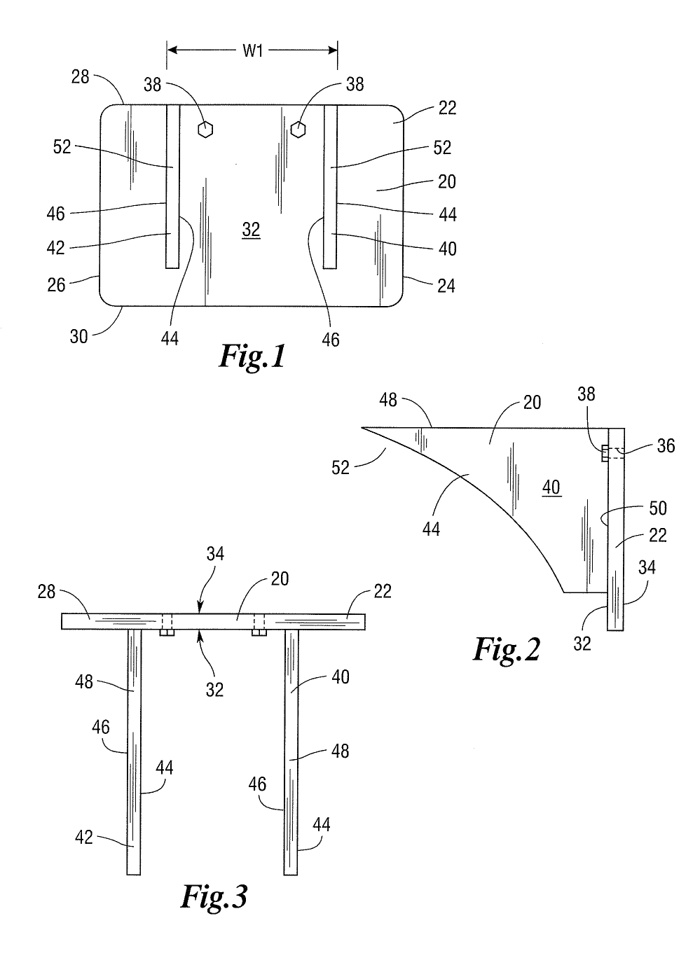

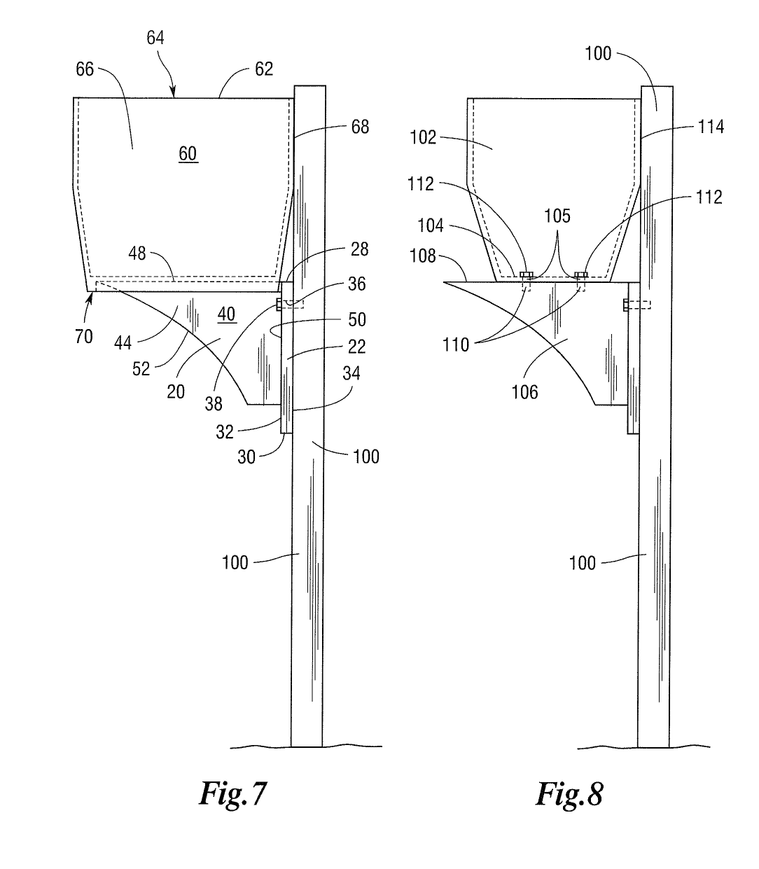

As shown in FIGS. 1-3 and 7 there is a wall flower pot mount 20. The wall flower pot mount 20 (hereinafter mount 20) has a backing member 22 having opposed first and second edges 24, 26, respectively, and opposed third and fourth edges 28, 30, respectively, and has opposed front wall and back walls 32, 34, respectively. The mount 20 has predrilled bores 36 for receiving fasteners, for example threaded bolts 38 so that the mount 20 can be joined to a structural wall 100, as shown in FIG. 7. Extending from the mount 20 are identically shaped first and second support members 40, 42, respectively, that are joined to the mount 20 and are substantially parallel to one another and spaced or separated from one another by a support member spacing width designated W1 in FIG. 1.

Each of the first and second support members 40, 42 has opposed flat sides commonly designated 44, 46, respectively. Each of the first and second support members 40, 42, respectively, has a straight support edge 48 that meets with straight mount edge 50, with a generally curved edge 52 extending between the straight support edge 48 and straight mount edge 50. Each of the first and second support members 40, 42, respectively, is joined to the mount 20 such that the mount edges 50 contact and are joined with the mount 20 with, for example, glue or screws. After joining the support edges 48 are perpendicular to the mount 20.

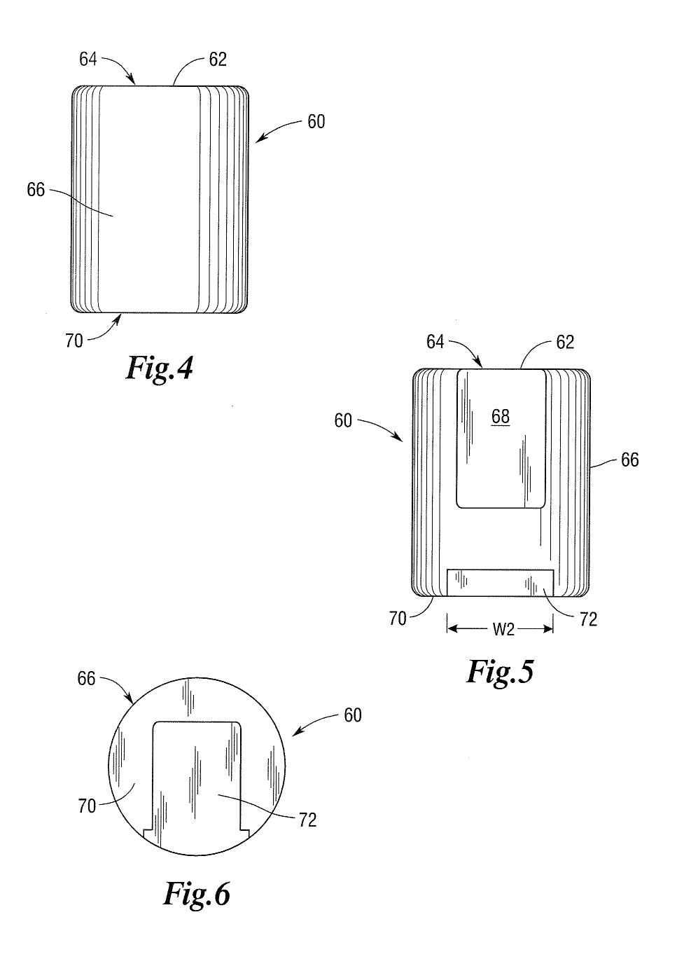

As shown in FIGS. 4-7, the flower pot 60 has a rim 62 that defines an opening 64, and a surrounding side wall 66 that has a flat portion 68, as shown in FIG. 5, that extends to a base 70. As shown in FIGS. 5 and 6 the surrounding side wall 66 has a recess 72 that extends into the flower pot 60, and the recess 72 has a recess width designated W2 that is greater than support member spacing width designated W1 and described above.

The flower pot 60 can thus be slidingly received on and supported by the first and second support members 40, 42, respectively, because W2 is greater than W1. In other words, the recess 72 is sized to accommodate the first and second support members 40, 42, respectively, therein. When the flower pot 60 is supported on the support members 40, 42, the flat portion 68 of the flower pot 60 abuts against the wall or vertical structure 100.

The flower pot 60 and first and second support members 40, 42, respectively, are made of plastics, clay, wood, metal, ceramics and combinations thereof or other suitable material. The method of forming and shaping these materials is well known to those having ordinary skill in the art.

In another embodiment shown in FIG. 8, there is a flat base flower pot 102 having a flat base 104 with fastener openings 105 that extend through the flat base 104. There is a pair of identically shaped spaced apart mounts 106 having support edges 108 having fastener recesses 110. When the flower pot 102 is positioned and supported on the mounts 106, the openings 105 in the flat base 104 align with the recesses 110 in the mounts 106, and fasteners 112, for example screws and bolts, are moved through the openings 105 in the base 104 of the flower pot 102 and into the recesses 110 in the mounts 106. The fasteners 112 are tightened, thus joining the flower pot 102 to the mounts 106. The flower pot 102 can also have a flat portion 114 that abuts against the wall 100.

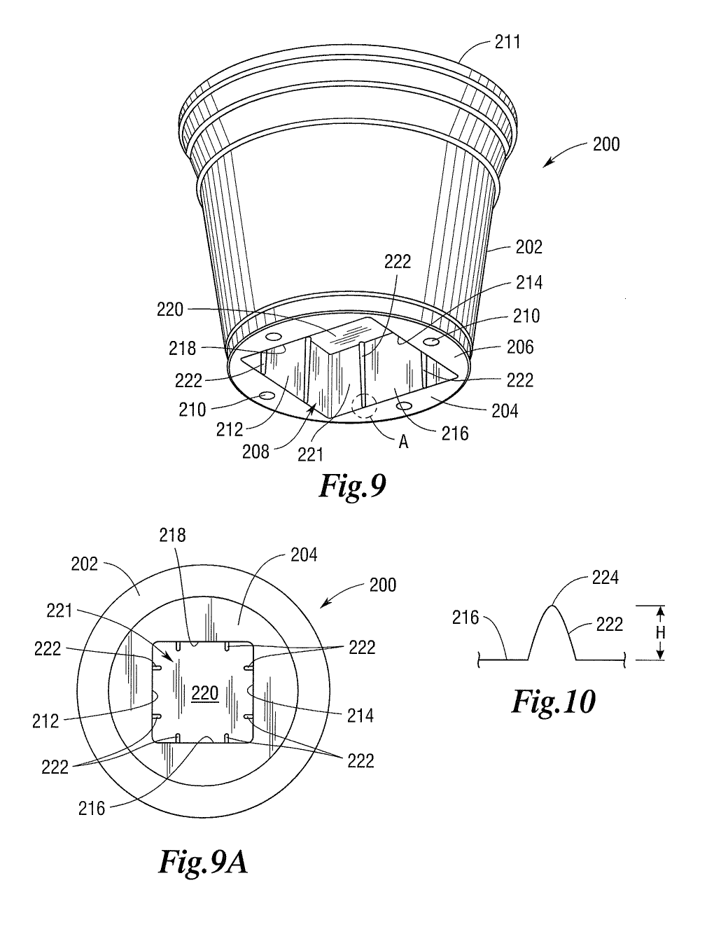

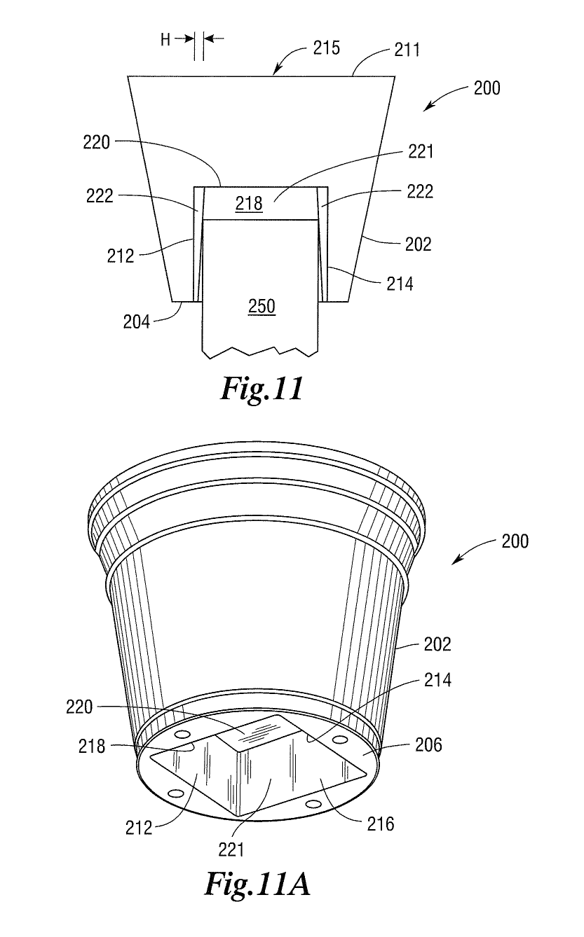

FIG. 9-11 show another embodiment which is a post flower pot 200. The post flower pot 200 has a surrounding side wall 202 that has a conical shaped, and in particular a truncated conical shape. There is a base 204 that meets with the surrounding side wall 202, and the base 204 has a flat portion 206 that extends to a base recess 208. The flat portion 206 has flow openings 210 that allow for water drainage. Opposite the base 204 the post flower pot 200 has a rim 211 that surrounds a plant opening 215, shown in FIG. 11, through which the plant and plant soil (not shown) is introduced into the post flower pot 200.

The post flower pot 200 has first and second opposed interior walls 212, 214, respectively, and third and fourth opposed interior walls 216, 218, respectively. The third interior wall 216 extends from the first interior wall 212 to the second interior wall 214, and the fourth interior wall 218 extends from the first interior wall 212 to the second interior wall 214. The first and second opposed interior walls 212, 214, respectively, are generally parallel to one another, and the opposed third and fourth interior walls 216, 218, respectively, are generally parallel to one another.

The first, second, third and fourth interior walls 212, 214, 216 and 218, respectively, extend from the base 204 to an internal elevated wall 220. The first, second, third and fourth interior walls 212, 214, 216 and 218, respectively, and the internal elevated wall 220 define a post recess 221 in the flower pot 200.

Ribs 222 protrude from each of the first, second, third and fourth interior walls 212, 214, 216 and 218, respectively. As shown, two ribs 222 protrude from each of the first, second, third and fourth interior walls 212, 214, 216 and 218, respectively, into the post recess 221. Each of the ribs 222 has an edge 224. The maximum height, designate H in FIG. 10, of the ribs 222 is the greatest where the ribs 222 meets with the internal elevated wall 220. The height H of the ribs 222 taper in a direction toward the base 204, and the minimum height of the ribs 222 is where the ribs 222 meet the base 204. The ribs 222 have a V-shaped cross section, as shown in FIG. 10, and crush or deflect when the post flower pot 200 is forced on a post 250 to hold the post flower pot and post 250 together by a friction fit or wedging to prevent movement of the post flower pot 200.

In one embodiment, the ribs 222 and post flower pot 200 can be made of plastic such that the ribs 222 deform and deflect when positioned on the post 250 as shown in FIG. 11, and return to their pre-deformed condition when the post flower pot 200 is lifted off the post 250. Thus, the post flower pot 200 is advantageously reuseable.

The ribs 222 advantageously allow the post flower pot 200 to be fitted on posts 250 having different dimensions. For example, the post flower pot 200 can be fitted on a post 250 that is, for example, four inches by four inches or three inches by three inches. In addition, other dimensioned posts 250 can be used, because the tapered ribs 222 crush and deflect to allow the post flower pot 200 to be fitted on these other dimensioned posts 250.

In other embodiments, the first, second, third and fourth interior walls 212, 214, 216 and 218, respectively, can each have at least one rib 222, or a plurality of ribs 222. In another embodiment at least one the first, second, third and fourth interior walls 212, 214, 216 and 218, respectively, has at least one internal rib 222. The number and location of the ribs 222 can be varied in different applications. And, another embodiment, the first, second, third and fourth interior walls 212, 214, 216 and 218, respectively, have a taper and taper inwardly in a direction toward the elevated internal wall 220.

In another embodiment, the surrounding side wall 202 could be formed with a flat portion, so that the post flower pot 200 can be fitted on a fence post 250 that is proximal a fence or wall.

In another embodiment shown in FIG. 11A, the post flower pot 200a has a surrounding wall 202a, and has first and second opposed interior walls 212a, 214a, respectively, and third and fourth opposed interior walls 216a, 218a, respectively, but does not have internal ribs 222, and is otherwise the same as the post flower pot 200 previously described. The first and second opposed interior walls 212a, 214a, respectively, and third and fourth opposed interior walls 216a, 218a, respectively, are flat and are perpendicular to the base 204a and define a post recess 221a. The base 204a also has a flat portion 206a, and the post recess 221a extends to an internal elevated wall 220a. In another embodiment, the first and second opposed interior walls 212a, 214a, respectively, and third and fourth opposed interior walls 216a, 218a, respectively, are tapered in a direction extending toward the internal elevated wall 220a. When the post flow pot 200a is placed on a post, for example post 250, the post 250 supports the post flower pot 220a.

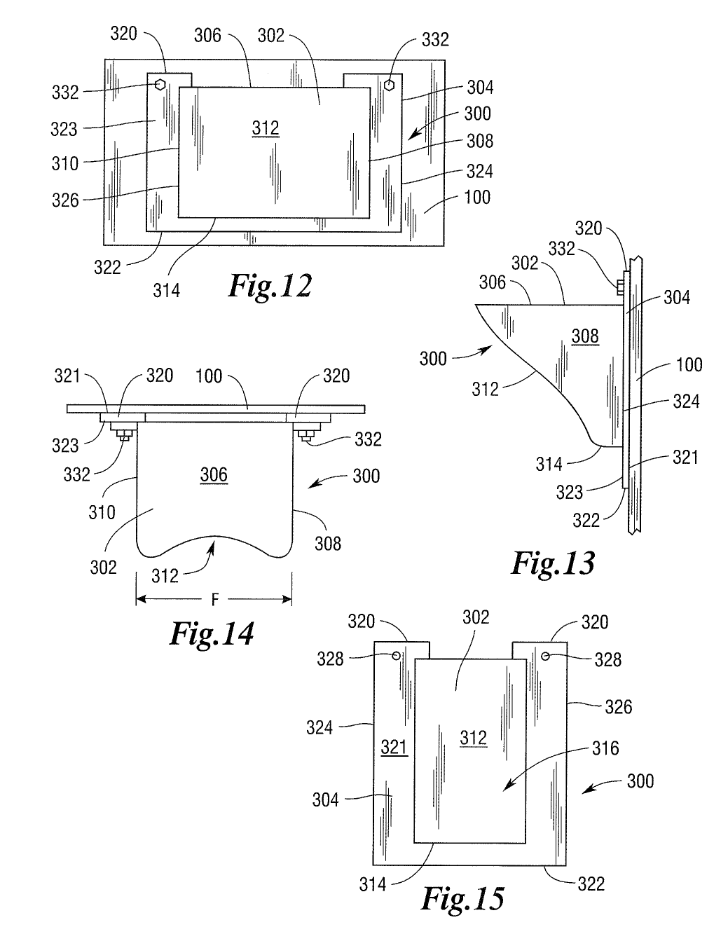

FIGS. 12-15 show another embodiment, and in particular a one piece wall flower mount 300. The one piece wall flower mount 300 is made of plastic, and can be blow molded or injection molded. Plastic and blow molding and injection molding plastic is well known to those having ordinary skill in the art. The one piece wall flower pot mount 300 is for use with the pot 102 described above in connection with the first embodiment, and a pot could be directly placed on the one piece wall flower mount 300.

The one piece wall flower pot mount 300 has a mount portion 302 that extends from a backing portion 304. The mount portion 302 has a support surface 306 for supporting the flower pot 102 thereon. The mount portion 302 has opposed first and second side surfaces 308, 310, respectively. The support surface 306 and a curved surface 312 that extends between the support surface 306 and an end portion 314 that extends to the backing portion 304. As shown in FIG. 15, the one piece wall flower mount 300 defines a recess 316, and is formed to be hollow. Thus, the end portion 314, the opposed first and second side surfaces 308, 310, respectively, and the support surface 306 all extend from the backing portion 304.

The backing portion 304 has a wall side 321 and an exposed side 323, and opposed first and second mount edges 320, 322, respectively, and opposed third and fourth mount edges 324, 326, respectively, that extend between the wall side 321 and the exposed side 323.

The backing portion 304 is joined to the mount portion 302 to form the one piece wall flower pot mount 300. There is an opening 326 formed in the backing portion 304 that leads to the recess 316 defined in the mount portion 302. There are also fastener openings 328 so that the one piece wall flower pot mount 300 can be connected to the wall or vertical structure 100, as shown in FIGS. 12-14, with fasteners 332. As previously described, the flower pot 102 has a recess formed in the base having a width designated W2. The width W2 is greater than the width, designated F in FIG. 14, of the mount portion 302, such that the flower pot 102 can be advantageously slidingly received on the mount portion 302.

Advantageously, the fasteners 332 are substantially obscured when the pot 102 is positioned on the support surface 306.

While the wall flower pot mount, a post flower pot and one piece wall flower pot mount inventions have been described in connection with certain embodiments, it is not intended to limit the scope of the invention to the particular forms set forth, but, on the contrary, it is intended to cover such modifications and equivalents as may be included within the spirit and scope of the invention as defined by the appended claims.

What is claimed:

1. A wall flower pot mount for mounting to a wall, the wall flower pot comprising:
a backing member for mounting to a wall,
spaced apart support members joined to the backing member and having support edges and separated by a support member spacing width,
a flower pot having a surrounding side wall having a base and a flat portion,
the flower pot having a recess formed in the base and the recess having a recess width and wherein the recess width is greater than support member spacing width, such that the flower pot can be slidingly received on the spaced apart support members and supported thereon, and
wherein the flat portion of the flower pot abuts against the wall when the flower pot is supported on the spaced apart support members.

2. A post flower pot comprising:
a surrounding side wall,
a base joined to the surrounding sidewall,
first, second, third and fourth interior side walls extending from the base to an internal elevated wall,
ribs formed on the first, second, third and fourth interior side walls that taper in a direction from the internal elevated wall to the base, such that a height of the ribs is at its minimum at the base.

3. The post flower pot according to claim 2 wherein the first, second, third and fourth interior side walls define a post receiving recess and wherein the ribs are for engaging a post.

4. A one piece wall flower pot mount for mounting to a wall and supporting a flower pot, the one piece wall flower pot comprising:
a backing portion joined to a mount portion joined,
the mount portion having a recess and the backing portion having an opening in communication with the recess, and
the mount portion having a support surface for supporting the flower pot.
